(19) United States
(12) Patent Application Publication
(10) Pub. No.: US 2010/0128806 A1
(43) Pub. Date: May 27, 2010

(54) METHOD FOR PLANNING A DIGITAL VIDEO BROADCASTING NETWORK

(75) Inventors: Indro Francalanci, Torino (IT); Daniele Franceschini, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TELECOM ITALIA S.P.A., Milano (IT)

(21) Appl. No.: 12/312,848

(22) PCT Filed: Nov. 30, 2006
(86) PCT No.: PCT/EP2006/011500

§ 371 Date: Jan. 14, 2010

(51) Int. Cl. H04L 27/28

(52) U.S. Cl. 375/260

(57) ABSTRACT

A method and a system for planning a digital video broadcasting network in a geographic area of interest includes simulating an electromagnetic field propagation in a plurality of area elements of the area of interest; for at least one area element of the plurality, performing a decoding of the simulated radio signals which, as a result of the simulating, are received at that area element, and based on a result of the decoding, determining a service coverage in the area of interest, wherein the network is a digital video broadcasting-handheld network and performing a decoding of the radio signals includes changing a position in time of a decoding time window, in particular, for determining the position wherein the ration signal/noise is maximum.

### FIELD OF THE INVENTION

The present invention generally relates to OFDM (Orthogonal Frequency Division Multiplex) telecommunications systems and methods, particularly to DVB (Digital Video Broadcasting) networks, and even more particularly to the planning of DVB-H (DVB-Handheld) networks. Specifically, the invention concerns a method of synchronizing the FFT decoding window in the planning phase of an OFDM network, and particularly of a DVB-H network.

### BACKGROUND OF THE INVENTION

DVB represents the technological evolution that is going to replace the analog TeleVision (TV) broadcasting systems used for more than 50 years.

In particular, due to the enormous popularity gained by personal mobile communications, a promising evolution of DVB is the DVB-H (DVB-Handheld) system, by means of which TV will be made available to users of mobile communications terminals like mobile phones.

As known to those skilled in the art, the DVB-H system is an SFN (Single-Frequency Network) system based on OFDM (Orthogonal Frequency Division Multiplex). In an SFN, all transmitters in the network use the same channel/frequency. The OFDM is a modulation system in which the information is carried via a large number of individual (sub-)carriers, in a frequency multiplex scheme; each (sub-)carrier transports only a relatively small amount of information, and high data capacities are achieved by using a large number of frequency-multiplexed carriers. Each carrier is modulated using QPSK (Quadrature Phase Shift Keying) and QAM (Quadrature Amplitude Modulation) techniques, and has a fixed phase and amplitude for a certain time interval, referred to as the “symbol time”, during which a small portion of the information, called “symbol”, is carried. After that time period, the modulation is changed and the next symbol carries the next information portion. The symbol time is the inverse of the (sub-)carrier spacing, and this ensures orthogonality between the carriers.

Modulation and demodulation are accomplished using the IFFT (Inverse Fast Fourier Transform) and the FFT, respectively.

In order to demodulate the received signal, the generic receiver has to evaluate the symbol during the symbol time. This involves properly positioning an FFT evaluation time window, i.e., properly “synchronize” the time window for the OFDM demodulation of the received signals.

The paper of R. Brugger and D. Hemingway, “OFDM receivers—impact on coverage of inter-symbol interference and FFT window positioning”, EBU Technical Review, July 2003, pages 1-12, offers a general overview of the possible strategies for FFT window synchronization in OFDM receivers. These strategies are equally applicable to the T-DAB (Terrestrial-Digital Audio Broadcasting) and DBV-T (Digital Video Broadcasting-Terrestrial) systems.

In such systems, signals generally arrive at a generic receiver following different paths, corresponding to multiple transmitters and/or echoes of a same transmitted signal, to which there are associated difference time delays; these different delays can cause ISI (Inter-Symbol Interference) at the receiver, because it is typically not possible to synchronize the FFT window to all the received signals: whichever the FFT window time positioning, there will always be some overlap with a preceding or following symbol in the transmission sequence. This ISI degrades the receivers performance.

In order to allow, as much as possible, a constructive combination of the signals getting to the receiver through different paths, OFDM systems with multipath capabilities have been proposed, in which a “guard time interval” (sometimes also referred to as “guard space”) is provided for. The guard time interval consists in a cyclic prolongation of the useful symbol time of the signal; essentially, the normal symbol duration is extended, so that a complete symbol comprises, in addition to a useful part, a cyclic prolongation of every symbol, whose time duration corresponds to the guard interval. In the cited paper of R. Brugger and D. Hemingway, the prolongation is obtained by copying part of the symbol from the beginning of the symbol to the end, increasing the duration of the guard interval.

Thanks to the provision of the guard interval, the OFDM receiver can position in time the FFT window so that there is no overlap with a preceding or subsequent symbol, thus reducing to a minimum the ISI.

The FFT window positioning which is materially performed by the generic receiver is not prescribed in detail in the network system specifications; all manufacturers have their own, proprietary and often undisclosed solutions. The above-cited paper of R. Brugger and D. Hemingway discloses five different strategies for the positioning of the FFT window in OFDM receivers: “strongest signal”, “first signal above a threshold level”, “centre of gravity”, “quasi-optimal” and “maximum C/I”.

In the “strongest-signal” approach the FFT window is synchronized to the strongest received signal (positioning for example the center of the FFT window at the center of the symbol to which the strongest signal corresponds). In the software tool named “DVB-Plan” by Wireless Future for the planning of DVB-T networks, the method adopted for positioning the FFT window is the synchronization to the best-server (i.e., strongest) signal.

In the “first signal above a threshold level” approach, the first signal above a predetermined threshold signal level serves as a trigger for the FFT window synchronization.

In the “centre of gravity” approach, the receiver looks at the impulse response, calculates the “centre of gravity” of the impulse response spectrum, and centers the FFT window on that point in time.

In the “quasi-optimal” approach, the first signal of the impulse response spectrum above a minimum threshold level is taken as a reference for the FFT window. If the value of the C/I (the ratio between the sum C of all the constructive signal contributions received at the receiver, to the sum I of all the remaining, interferential contributions) is good enough to allow demodulation, the FFT window is aligned to the beginning of a symbol carried by such a signal, otherwise the receiver looks for any other signal in the time impulse response that is above the predetermined threshold: if no such signal is found, the FFT window is aligned to the beginning of a symbol of the signal that allows the greatest C/I value, otherwise the FFT window is aligned with the next signal in the impulse response that exceeds the predetermined threshold value.

Finally, in the “maximum C/I” approach, the FFT window is positioned so that the effective C/I value is maximized. In connection with this technique, the paper of R. Brugger and D. Hemingway states that this approach has drawbacks with respect to the others: it requires too much time to be calculated, it is unsuitable in some conditions (such as in a two-echo case when the difference in delay is close to the guard interval) and can have theoretical limits in some other conditions.

EP 1079579 describes an OFDM frame synchronization method intended to be implemented by a receiver in which a frame synchronization pulse is generated by deriving absolute values of successive complex samples of the OFDM symbol, determining the difference between such values and other values separated therefrom by a period representing the useful part of the OFDM symbol, integrating the difference values over a plurality of symbols and determining the sample position representing the point at which the integrated difference values substantially change.

The White Paper of Emmanuel Grenier, ATDI, “DVB-H radio planning aspects in ICS telecom”, July 2006, available on the web site www.atdi.com/docs/WP_DVBH-planning_ICStelecom.pdf, addresses the problem of efficient planning of DVB-H networks with ICS telecom. In dense urban areas, the network is usually densified with transponders in order to achieve deep-indoor coverage; the reflections on the buildings sides might generate a self-interference case between the reflected symbols of the same signal coming from a given transponder. In multi-signal environment, the suggested approach is synchronization to the strongest signal.

### SUMMARY OF THE INVENTION

The Applicant has tackled the problem of providing a technique for planning a digital video broadcasting network, which is particularly suitable for transmitting video signals in both outdoor and indoor environments, in particular in urban areas.

The Applicant has observed that, although DVB-H networks seem to be the most suitable approach for broadcasting digital TV signal on an eterogeneous area, the criteria adopted in known DVB network planning tools are not satisfactory in the case of DVB-H networks. In fact, since DVB-H is devoted to broadcasting TV to mobile terminals like mobile phones, a DVB-H network is almost always characterized by the presence of transmitting stations that are very different in nature: several low-height and relatively low-power transmission sites (“stations”), of limited radio coverage range (of the order of few kilometers), essentially corresponding to the transceiver stations of a mobile telephony network, and few “elevated” and high-power, dominant transmission sites, corresponding to the broadcasting TV antennas, having a much wider radio range (of the order of 100 Km).

This network topology determines peculiar conditions of signal echoes at the receivers, which, if not properly taken into account in the very network planning phase, may cause substantial errors.

In particular, the Applicant has observed that when a DVB-H network with elevated and low-height transmission stations is to be planned, the assumption that the receivers synchronize the position of the FFT window to the best-server (i.e., the strongest) signal provides an unsatisfactory network dimensioning. Indeed, in the above-described scenario of a DVB-H network comprising several low-height transmission stations and few dominant transmission stations, a generic DVB-H receiver (e.g., a DVB-H mobile phone) will in general receive several relatively feeble signals of relatively low strength, originating and irradiated from the low-height transmission stations, and one, or few, relatively stronger signals, originating and irradiated from the dominant transmission station(s). The signals coming from the low-height transmission stations are generally close to each other, in terms of time delay, whereas the signal(s) coming from the dominant transmission station(s), which is(are) most of times far away from the receiver more than the low-height transmission stations, are affected by significant time delays, of more than 250 μs (which is a typical value for the guard time). In addition, echoes of these signals may be received as well, especially in indoor environments, due to reflection on building sides.

Nevertheless, the strongest signal(s) perceived by a generic receiver would often be the one(s) that is(are) transmitted by high, dominant transmission stations: thus, taking that signal as a reference for positioning in time the FFT window would produce a lot of ISI, because the signals that are received from the low-height transmission stations would in such a case fall outside the guard time interval.

As a consequence, network planning tools that are based on the assumption that receivers synchronize the FFT windows on the strongest signals can produce an erroneous estimation of the signal interference caused by signals coming from multiple paths. Therefore, these known planning tools provide an erroneous estimation of the DVB-H service areas, and in particular the estimation of the indoor service coverage is underestimated.

The Applicant has also observed that the above problem is typical of DVB-H networks. In a DVB-T network, for example, where single areas of interest are covered by a single broadcast signal emitted by an elevated transmission station, each receiver will typically receive one strong signal and possible echoes thereof, and it is very unlikely that the strong signal follows the other signals with a substantial delay.

The Applicant has found that by considering in the planning process both elevated and low-height transmission stations, like in DVB-H networks, and a demodulation technique that includes changing in the decoding phase the position in time of the FFT window, in particular based on the attempt to maximize the signal-to-noise ratio, a network particularly suitable for broadcasting video signals in both outdoor and indoor environments can be efficiently planned. In fact, the signal contributions deriving from both the elevated and low-height transmission stations are taken into considerations in the proper way.

The present invention thus relates to a method for planning a digital video broadcasting network in a geographic area of interest, comprising simulating an electromagnetic (EM) field propagation in a plurality of area elements (pixels) of the area of interest; performing, for at least one area element of said plurality, a decoding of the simulated radio signals which, as a result of the step of simulating, are received at that area element; and determining, based on a result of said decoding, a service coverage in the area of interest; wherein the network is a DVB-H network and performing a decoding of the radio signals comprises changing a position in time of a decoding time window.

Preferably, simulating an EM field propagation in a plurality of area elements of the area of interest comprises providing an initial configuration of the network in the area of interest; providing a morphological description of the area of interest; dividing the area of interest into a plurality of area elements; and simulating a propagation of radio signals through the area of interest based on said initial configuration of the network.

Preferably, performing a decoding comprises calculating a signal-to-noise ratio. In particular, changing the position in time of the decoding time window comprises attempting to maximize the signal-to-noise ratio.

Calculating the signal-to-noise ratio preferably comprises considering as constructive contributions all the radio signals that, as a result of said simulating, are received at the area element within the decoding window, and considering as interferential contributions all the radio signals that, as a result of said simulating, are received outside the decoding window.

The decoding window can be rectangular, trapezoidal, or of another similar shape.

Moreover, calculating the signal-to-noise ratio preferably comprises treating the simulated signals as statistical distributions.

In fact, the Applicant has found that, in order to properly describe, from the statistical viewpoint, the sum of the different signals which, in the simulation, are received at the generic pixel, the statistical distributions of the corresponding linear variables (expressed in mW) must be considered; in particular, the Applicant has found that the statistic sum must be performed in the linear field, by adding separately average values and variances. In particular, the average value and the variance of the power of the useful signal are calculated as the sum of the average values and variances of constructive contributions; the same is done for the interference I, considering interferential contributions. The variables are then retransformed in the logarithmic field, where the signal-to-ratio is computed.

Therefore, first a transformation from a logarithmic unit (dBm) into a linear unit (mW) is carried out, then some processing is performed in the linear field, and then a retransformation from linear unit (mW) into logarithmic unit (dBm) is carried out, where the signal-to-ratio is computed. Tranformations are carried out passing through neper variables.

Accordingly, considering that the signal-to-noise ratio is the ratio between a useful signal and a noise, the step of calculating the signal-to-noise ratio may comprise:
transforming average values and variances of the received radio signals from the logarithmic unit into a linear unit;
calculating an average value and a variance of the useful signal as a sum of the average value and, respectively, of the variance of the constructive signal contributions, expressed in the linear unit;
calculating an average value and a variance of the noise as a sum of the average value and, respectively, of the variance of the interferential contributions, expressed in the linear unit;
converting the calculated average value and variance of the useful signal from the linear unit into the logarithmic unit;
converting the calculated average value and variance of the noise from the linear unit into the logarithmic unit;
calculating an average value of the ratio between the useful signal and the noise in the logarithmic unit as a difference of the average values of the useful signal and of the noise in the logarithmic unit; and
calculating a variance of the ratio between the useful signal and the noise in the logarithmic unit as a sum of the variances of the useful signal and of the noise in the logarithmic unit.

The present invention also relates to a computer program comprising instructions adapted to implement the method as defined above.

Moreover, the present invention relates to a data processing system adapted to implement the method as defined above when programmed to execute such computer program.

Other aspects of the invention concerns a computer program and a data processing system that, when programmed by the computer program, is adapted to implement the method of the first aspect.

### BRIEF DESCRIPTION OF THE DRAWINGS

The features and advantages of the present invention will result apparent by reading the following detailed description of an embodiment thereof, provided merely by way of non-limitative example, and referring to the annexed drawings, wherein:

FIG. 1 pictorially shows a portion of a geographic area covered by a DVB-H network, with elevated, wide-range transmission stations and low-height, reduced radio range transmission stations;

FIG. 2 illustrates the concepts of “guard time interval” and “FFT window positioning”;

FIG. 3 schematically shows a subdivision into elementary area elements, or pixels, of the portion of geographic area of FIG. 1 used in a network planning phase, according to an embodiment of the present invention;

FIG. 4 schematically shows the main functional components of a data processing apparatus that, suitably programmed, is adapted to carry out a DVB-H network planning method according to an embodiment of the invention;

FIG. 5 schematically shows the main components of a computer program that, when executed on the data processing apparatus of FIG. 4, implements a DVB-H network planning method according to an embodiment of the present invention;

FIG. 6 is a schematic flowchart showing the main steps of a DVB-H network planning method according to an embodiment of the present invention;

FIG. 7 pictorially shows an FFT window synchronization procedure according to an embodiment of the present invention; and

FIG. 8 is a schematic flowchart showing the main steps of a preferred procedure for calculating a C/I ratio adopted in the network planning method of FIG. 6, according to an embodiment of the present invention.

### DETAILED DESCRIPTION OF THE PREFERRED EMBODIMENT OF THE INVENTION

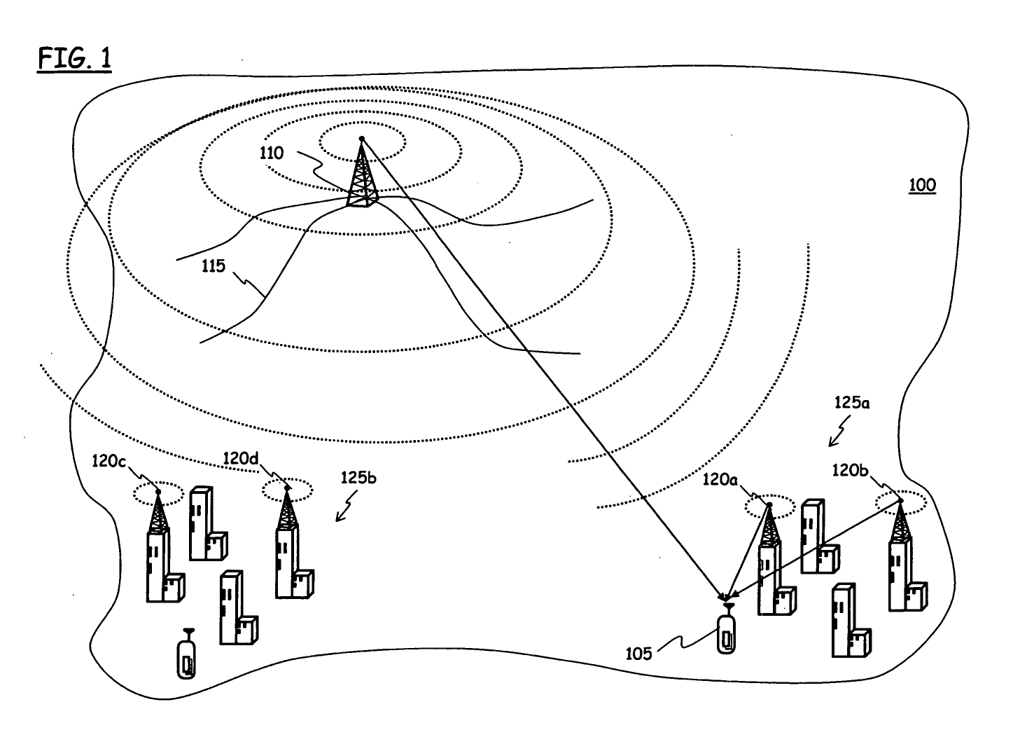

Making reference to FIG. 1, there is schematically shown a portion of a geographic area 100 covered by a DVB-H network, for broadcasting TV to DVB-H mobile terminals, like mobile phones 105; the geographic area 100 is assumed to be an area under planning of the DVB-H network.

The scenario depicted in FIG. 1, rather typical for DVB-H networks, is characterized by the presence of transmitting stations that are very different in nature: several “low-height” transmission stations, of reduced radio range (of the order of few Kilometers), located for example in correspondence of the transceiver stations (BTSs—Base Transceiver Stations—of a GSM network, Node Bs of a UMTS network) of a mobile telephony network, and few “elevated”, dominant transmission stations, corresponding to the broadcasting TV antennas, having a much wider radio range (of the order of 100 Km). In particular, looking at FIG. 1, just one elevated transmission station 110 is shown, for the sake of simplicity, depicted as located on top of a hill or mountain 115, working in conjunction with four low-height transmission stations 120a, 120b, 120c and 120d, the first two being distributed in a first urban area 125a (e.g. a town, or a village), the second two being distributed in a second urban area 125b.

Considering a hypothetic DVB-H terminal (a DVB-H receiver) 105 located for example in the first urban area 125a, it will receive the relatively low-strength radio signals irradiated by the low-height transmission stations 120a, 120b distributed across the urban area 125a (particularly, the DVB-H terminal will receive the radio signals irradiated by those, among the transmission stations 120a, 120b, that are located in the neighborhood of the DVB-H terminal 105), and the relatively strong signal irradiated by the elevated site 110, together with the respective echoes.

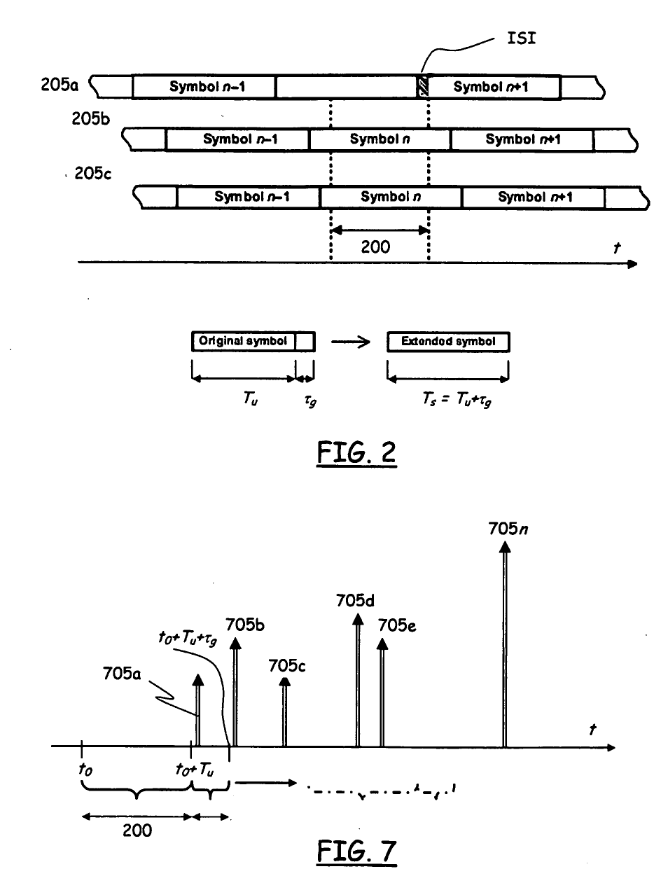

Referring to FIG. 2, as discussed in the foregoing, in order to demodulate the received signals, the DVB-H receiver has to evaluate the symbol during the symbol time. This involves properly positioning an FFT evaluation time window 200, having a time duration equal to the useful symbol time Tᵤ of the signal.

Different time delays are associated with different signals 205a, 205b, and 205c that arrive at the DVB-H receiver following different paths, corresponding for example to the transmission stations 110, 120a, and 120b, and possibly to echoes of a same transmitted signal. Just three signals are shown, however in a real case the number of signals that a generic receiver receives may be higher. In order to allow, as much as possible, a constructive combination of the different signals arriving at the receiver, a guard time interval τ_{g} is provided for, thereby the useful symbol time Tᵤ of the signal is cyclically extended to obtain an extended symbol time Tₛ by adding a cyclic extension or a cyclic prefix of every symbol, preceding or following the useful part of each symbol and containing a repetition of the data at the end, or respectively at the beginning of the useful symbol part. In other words, part of the symbol is copied from the beginning of the symbol to the end, or from the end of the symbol to the beginning. Those signals that are received with a delay than cannot be compensated by the guard time cause a worsening of the received signal, and are therefore regarded as interference.

With the provision of the guard interval τ_{g}, the DVB-H receiver can position the FFT window in such a way as to reduce ISI.

In particular, the DVB-H receiver is synchronized in two phases: in a first phase, an initial synchronization is performed, in which the receiver is temporally aligned to the symbol rate; in a second phase, a secondary synchronization is performed, in which the receiver positions the FFT window for demodulating the received signal.

Once the position of the FFT window has been determined, the DVB-H receiver calculates a useful received signal C as the sum of all the received signals C, that contribute constructively, i.e. the received signals that fall within the FFT window extended by the guard time τ_{g}, and the interference I is calculated as the sum of the remaining received signals, that contribute interferentially. The DVB-H receiver will consider as constructive contributions the received signals that fall within the FFT window and as interference the received signals that fall outside the FFT window, according to the following formulas:

C=ΣᵢWᵢCᵢ

I=Σᵢ(1−W)ᵢCᵢ

where the weight coefficient Wᵢ is calculated as follows (the variable t identifying the time at which a generic signal I is received):

$${W}_{i} = \{ \begin{matrix}0 & if & t \leq {t}_{0} \\ 1 & if & {t}_{0} < t \leq {t}_{0} + {T}_{u} \\ 0 & if & {t}_{0} + {T}_{u} < t\end{matrix}$$

It has to be noted that in the FFT window has been considered of rectangular shape for the sake of simplicity, but it could have a different shape, such as a trapezoidal shape, thus including different weights.

A typical guard time is of 250 μs, corresponding to signal paths differing of about 70 Km. In a scenario like that depicted in FIG. 1, which is rather true-to reality, the elevated transmission stations, like the transmission station 110, having a wide radio range, often happen to be away from, e.g., urban areas like the urban area 125a a distance of the order of a few hundreds of kilometers; thus, while the signals received by the generic DVB-H receiver and coming from the low-height sites like the sites 120a, 120b (either directly or after signal reflections) are generally rather close to each other, in terms of time delay, and thus they fall within the FFT window or within the guard time, the signal(s) coming from the elevated transmission station(s), like the site 110, having to travel for a significantly longer path arrives at the DVB-H receiver with a significant time delay, of more than the typical guard time value of 250 μ.

Known DVB-H network planning tools that operate on the basis of the assumption that DVB-H receivers synchronize the FFT windows on the strongest signals produce an erroneous estimation of the signal interference caused by signals coming from multiple paths, because in a scenario like that depicted in FIG. 1 the strongest signal received by a generic DVB-H receiver like the mobile terminal 105 is often the signal irradiated by an elevated transmission station, like the station 110, but this signal is at the same time the more delayed, compared to the signals received from the low-height, closer transmission stations 120a, 120b. As a consequence, these known planning tools provide an erroneous estimation of the service areas, and in particular the indoor service coverage is underestimated.

The method according to the invention embodiment which will be hereinafter described allows overcoming the limitations of prior-art DVB-H network planning methods.

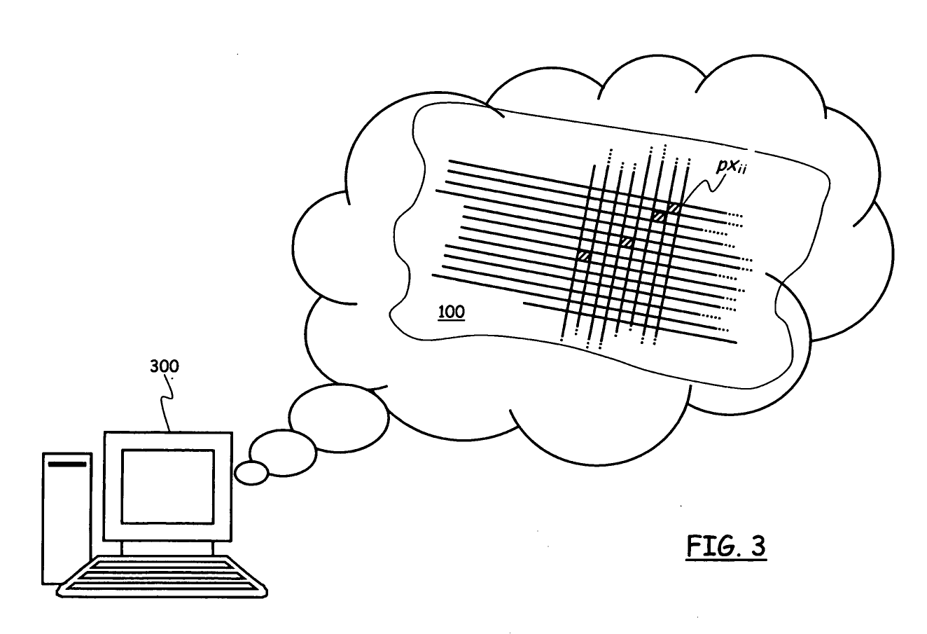

Referring to FIG. 3, there is schematically depicted a data processing apparatus 300, which, in one embodiment of the present invention, is used for planning the DVB-H network (for example in respect of the portion of geographic area 100 shown in FIG. 1). The data processing apparatus 300 may be a general-purpose computer, like a Personal Computer (PC), a workstation, a minicomputer, a mainframe, and it may as well include two or more PCs or workstations networked together.

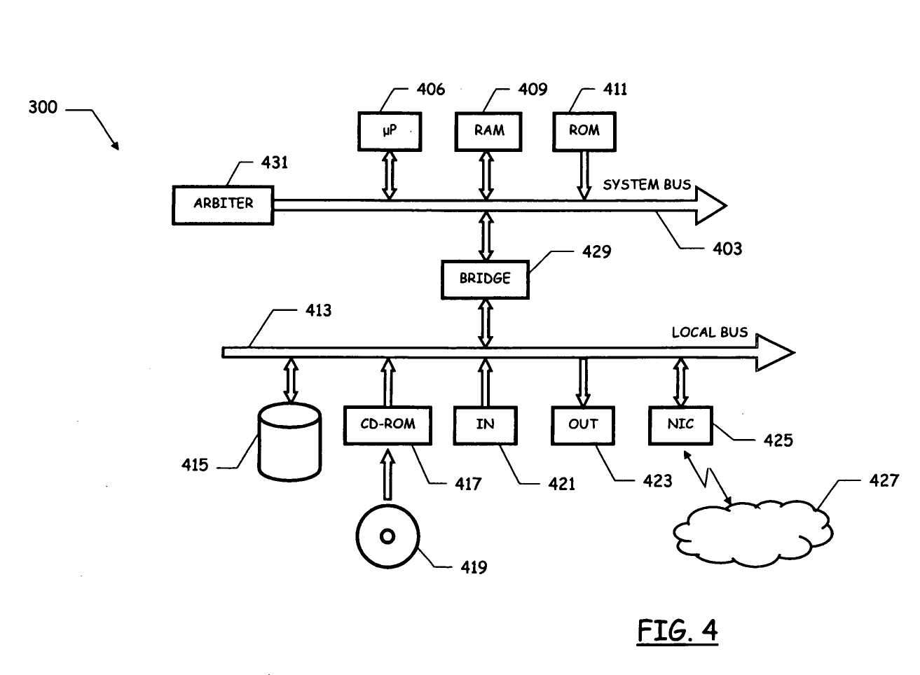

The general structure of the data processing apparatus 300 is schematically depicted in FIG. 4. The data processing apparatus 300 comprises several units that are connected in parallel to a system bus 403. In detail, one (possibly more) data processor (μp) 406 controls the operation of the computer 300; a RAM 409 is directly used as a working memory by the microprocessor 406, and a ROM 411 stores the basic code for a bootstrap of the computer 300. Peripheral units are connected (by means of respective interfaces) to a local bus 413. Particularly, mass storage devices comprise a hard disk 415 and a CD-ROM/DVD-ROM drive 417 for reading CD-ROMs/DVD-ROMs 419. Moreover, the computer 300 typically includes input devices 421, for example a keyboard and a mouse, and output devices 423, such as a display device (monitor) and a printer. A Network Interface Card (NIC) 425 is used to connect the computer 300 to a network 427, e.g. a LAN. A bridge unit 429 interfaces the system bus 403 with the local bus 413. Each microprocessor 406 and the bridge unit 429 can operate as master agents requesting an access to the system bus 403 for transmitting information; an arbiter 431 manages the granting of the access to the system bus 403.

With reference again to FIG. 3, the planning of the DVB-H network calls for ideally subdividing the geographic area of interest into relatively small, elementary area elements or pixels pxᵢⱼ (where i and j are two indexes which take integer values to span the area of interest), each pixel being an elementary, unit (in the shown example, square) area of predefined width, e.g. a 50 m by 50 m square.

In the planning of the DVB-H network, the generic pixel pxᵢⱼ is assumed to represent a virtual DVB-H receiver, i.e. it is assumed that, in the generic pixel, at least one DVB-H receiver is located.

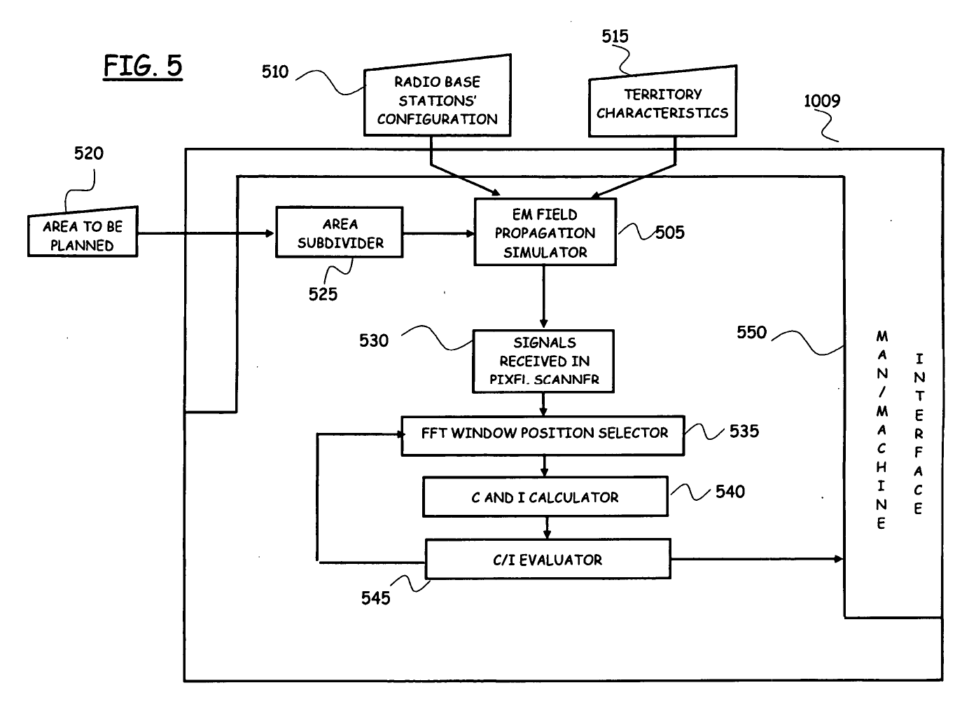

In FIG. 5, functional blocks that, in an embodiment of the present invention, may represent components or modules of a computer program adapted to be executed by the data processing apparatus 300 to implement a DVB-H network planning method according to an embodiment of the present invention are schematically shown. In particular, FIG. 5 schematically depicts a partial content of the working memory 409 of the data processing apparatus 300. The information (programs and data) is typically stored on the hard disk and loaded (at least partially) into the working memory when the program is executed. The programs may be initially installed onto the hard disk from, e.g., CD-ROMs or DVD-ROMs, or they may be downloaded from, e.g., a distribution server machine through the data communications network 427.

An electromagnetic field propagation simulator module 505 simulates the electromagnetic field in the area of interest, given an initial configuration 510 of DVB-H network (number and positions of the transmitting sites, radio equipment and the like) and the characteristics 515 of the territory in the area of interest 100, which are inputs to the program. A further input to the program is a description 520 (including a map) of the area under planning, which is fed to an area subdivider module 525 adapted to subdivide the area under planning into a plurality of elementary area elements or pixels pxᵢⱼ as illustrated in FIG. 3. The subdivision in pixels is provided to the electromagnetic field propagation simulator module 505, so that the electromagnetic field in the different pixels can be simulated. A module 530 is adapted to scan the signals that, based on the electromagnetic field distribution that is simulated by the module 505, are received at each pixel of the area under planning. An FFT window position selector module 535 is adapted to position the FFT window that is used to simulate a DVB-H receiver demodulation process carried out by a virtual DVB-H receiver associated to each pixel. The FFT window position is fed to a C and I calculator module 540, that calculates the value C of the cumulated constructive contributions (the “useful signal”) and the value I of the interference (the “noise”), given that FFT window position. The calculated C and I values are fed to a C/I evaluator module 545, which is adapted to evaluate the value of the ratio C/I for the different possible FFT window positions. A man/machine interface 550 (e.g. a Graphical User Interface—GUI) is provided for the interaction of the network designer with the data processing apparatus 300.

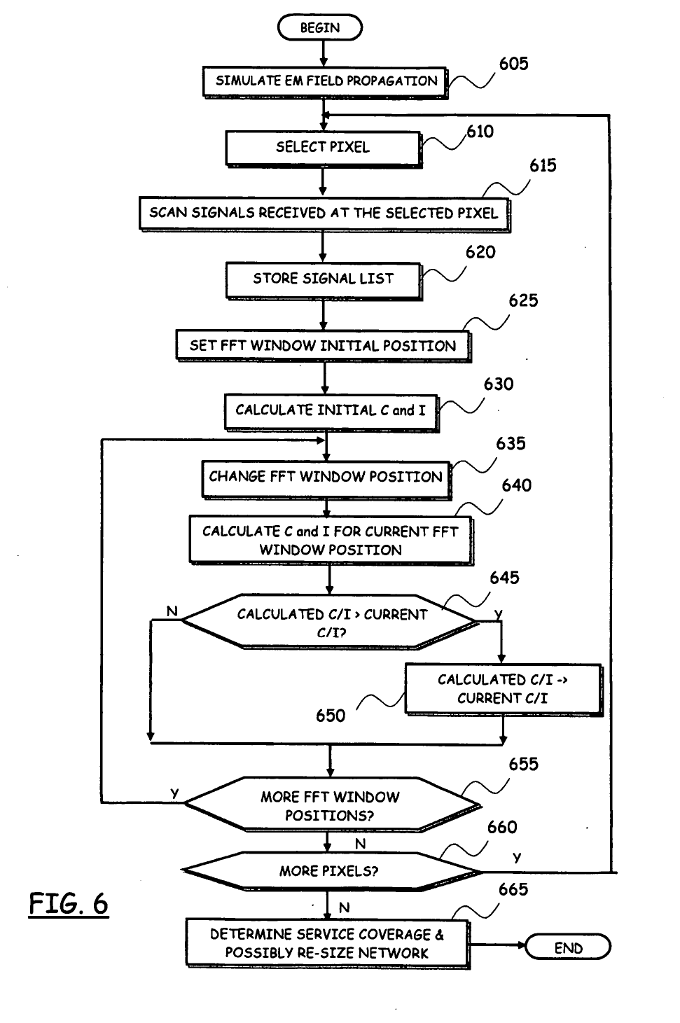

The schematic flowchart of FIG. 6 schematically shows the main steps of a DVB-H network planning method according to an embodiment of the present invention.

Firstly, based on a current DVB-H network topology (number and locations of transmissions sites, radio equipment thereof, etc.) and data related to the nature of the geographic area being planned (describing the morphology of the territory, like orography, the presence of rivers, woods, forests, the density of buildings, etc.), a distribution of the electromagnetic field originating from the transmission stations is simulated, for every pixel of the area under planning (block 605).

Then, all the pixels of the area under planning are investigated: for each pixel (block 610), the radio signals that, based on the simulation, are received at that pixel are scanned (block 615), and the list of detected signals is stored (block 620).

The generic pixel is, as mentioned above, assumed to be a virtual DVB-H receiver; in particular, according to an embodiment of the present invention, every pixel is assumed to be a virtual DVB-H receiver that, in order to position the FFT window for the decoding of the received signals, adopts a criterion based on the maximization of the value of the C/I ratio. To this purpose, according to an embodiment of the present invention, an initial position for the FFT window is set (block 625); for example, referring to FIG. 7, the FFT window 200 is positioned in such a way that only the first received signal 705a is considered as a constructive contribution (also taking account of the guard time), thus regarding all the remaining signals 705b, 705c, 705d, 705e, . . . , 705n as interferential contributions. An initial current value for C and I, and then of the C/I ratio, is thus calculated (block 630) and stored as a current C/I value.

The FFT window position is then changed (block 635) so as to embrace also the following received signal 705b. The value of the C/I ratio for the current FFT window position is then re-calculated (block 640), and the calculated C/I value is compared to the current C/I value (block 645): if the newly calculated CA value is higher than the current C/I value (exit branch Y of block 645), the newly calculated value, corresponding to the new position of the FFT window, becomes the new current C/I value (block 650), otherwise the current C/I value is retained (exit branch N of block 645). These actions are repeated for all the possible FFT window positions (block 655), in particular for all the possible FFT window positions that differ for the signals embraced by the window, and for all the pixels in the area under planning (block 660). It has to be noted that as the window is shifted in one direction (for example from left to right) to embrace progressively new signals, the first embraced signals could exit the window.

The DVB-H network planning then proceeds with the estimation of the service area coverage (block 665), determined on the basis on the best C/I value calculated for each pixel as just described. If necessary or desired, the network designer may decide to modify the network topology, by adding/removing transmission stations, by increasing/decreasing the respective transmission power so as to reduce the interference, and so on; the above procedure can then be repeated once or more so to estimate the new service coverage.

The planning method according to the described embodiment of the present invention provides better results than known planning software tools, and in particular it allows better estimating the service areas, and in particular avoids underestimating the indoor service coverage.

A possible way to calculate the values C and I is to add up the powers (expressed in dBm) of the signals that are received at the pixel from time to time being considered.

However, the Applicant has found that this sum would be meaningless, from a physical viewpoint.

Hereinafter, a preferred method for calculating the value of the C/I ratio is described, according to an embodiment of the present invention; it is however pointed out that the method adopted for calculating the C/I ratio is not per-se limitative for the present invention, and any method can be adopted.

In particular, the method described hereinbelow is based on the observation that since in the planning phase area elements of finite geometric dimensions are considered as the virtual DVB-H receivers, a proper description of the electromagnetic field in each pixel should be statistical in nature, so as to take into account the variations of the field across the pixel area; also, statistical variations in time should preferably be considered, to take into account phenomena like the fading effects. Thus, the strength (power) of the signals that, in the above-described operation flow, are considered as received in the generic pixel (based on the simulation results), are to be treated as stochastic variables.

Considering a generic, linear stochastic variable y (like for example a variable representing the power of a radio signal, expressed in watts or milliwatts), it can be said that the linear variable y has a lognormal distribution if the corresponding logarithm x=lny has a normal (i.e., Gaussian) distribution, i.e. if:

$$p ( x ) = \frac{1}{\sqrt{2 π} \cdot {σ}_{x}} {e}^{- \frac{{( x - {μ}_{x} )}^{2}}{2 {σ}_{x}^{2}}} , p ( y ) = \frac{1}{\sqrt{2 π} \cdot {σ}_{x}} \cdot \frac{1}{y} {e}^{- \frac{{( ln y - {μ}_{x} )}^{2}}{2 {σ}_{x}^{2}}} .$$

Let a generic pixel of the area under planning, where the signals coming from n different transmission stations are received. Let Pᵢ[dBm] denote the local average value (expressed in dBm) of the power of the signal received in the considered pixel from the i-th transmission station; Pᵢ[dBm] is a stochastic variable having a Gaussian distribution with average value μ_{P}_{ᵢ}, [dBm] and standard deviation σ_{P}_{ᵢ}[dBm].

As mentioned above, despite it could be possible to perform the statistic sum of the powers of the n signals received at the pixel considered (under the assumption that the received signals are statistically independent, the sum is again a Gaussian variable, with average value equal to the sum of the average values, and variance equal to sum of the variances), this sum would be meaningless, from a physical viewpoint.

In order to properly describe, from the statistical viewpoint, the sum of the different signals which, in the simulation, are received at the generic pixel, the statistical distributions of the corresponding linear variables (expressed in mW) are considered, and they are statistically added to each other.

Therefore, according to an aspect of the present invention, there is a transformation from a logarithmic unit (dBm) into a linear unit (mW), some processing in the linear field, and then a retransformation from linear unit (mW) into logarithmic unit (dBm).

In order to pass from the simulated signal powers expressed in dBm to the expression thereof in mW, the dBm variables are firstly transformed into neper variables, exploiting the following equation:

$${μ}_{{P}_{i}} [ neper ] = \frac{1}{10 {log}_{10} e} \cdot {μ}_{{P}_{i}} [ dBm ] \\ {σ}_{{P}_{i}} [ neper ] = \frac{1}{10 {log}_{10} e} \cdot {σ}_{{P}_{i}} [ dBm ] \qquad ( 1 )$$

Using neper variables, it is possible to express the average μ_{P}_{ᵢ}[lin] and the standard deviation σ_{P}_{ᵢ}[lin] of the lognormal distribution of the corresponding linear variables Pᵢ[lin] as:

$${μ}_{{P}_{i}} [ lin ] = {e}^{{μ}_{{P}_{i} [ nep ] + \frac{{σ}_{{P}_{i}}^{2} [ nep ]}{2}}} \\ {σ}_{{P}_{i}}^{2} [ lin ] = {e}^{2 \cdot {μ}_{{P}_{i}} [ nep ] + {σ}_{{P}_{i}}^{2} [ nep ]} \cdot ( {e}^{{σ}_{{P}_{i}}^{2} [ nep ]} - 1 ) \qquad ( 2 )$$

Let it be assumed that the sum of n stochastic variables with lognormal distribution is again a stochastic variable P[lin] with lognormal distribution, having average value μ_{P}[lin] equal to the sum of the averages, and variance σ_{P}²[lin] equal to the sum of the variances (the contribute of the co-variance is neglected, in the hypothesis that the n signals are statistical independent; in reality, the signals are not really independent, because the effect of shadowing to which they are affected is strongly dependent on the position of the mobile terminal):

$$\begin{matrix}{μ}_{P} [ lin ] = {\sum }_{i} {μ}_{{P}_{i}} [ lin ] \\ {σ}_{P}^{2} [ lin ] = {\sum }_{i} {σ}_{{P}_{i}}^{2} [ lin ] \\ Since \text{:} & ( 3 ) \\ {μ}_{P} [ nep ] = {ln}_{e} ( {μ}_{P} [ lin ] ) - \frac{1}{2} \cdot {ln}_{e} ( \frac{{σ}_{P}^{2} [ lin ]}{{μ}_{P}^{2} [ lin ]} + 1 ) \\ {σ}_{P}^{2} [ nep ] = {ln}_{e} ( \frac{{σ}_{P}^{2} [ lin ]}{{μ}_{P}^{2} [ lin ]} + 1 ) & ( 4 )\end{matrix}$$

the average μ_{P}[dBm] and the variance σ_{P}²[dBm] of the Gaussian distribution describing the stochastic variable in logarithmic units P[dBm] can now be derived from:

μ_{P}[dBm]=10·log₁₀ e·μ_{P}[nep]

σ_{P}[dBm]=10·log₁₀ e·σ_{P}[nep] (5)

It is remarkable that the average of the neper variables, and thus the average in dBm variables, depend not only on the average of the linear variables, but also on the variance of the linear variables; similarly, the variance of the neper variables, and thus the variance in dBm variables, depend not only on the variance of the linear variables, but also on the average of the linear variables.

The above procedure is the proper way to add up different contributions, either constructive or interferential, during the planning phase, taking into account of their statistic nature.

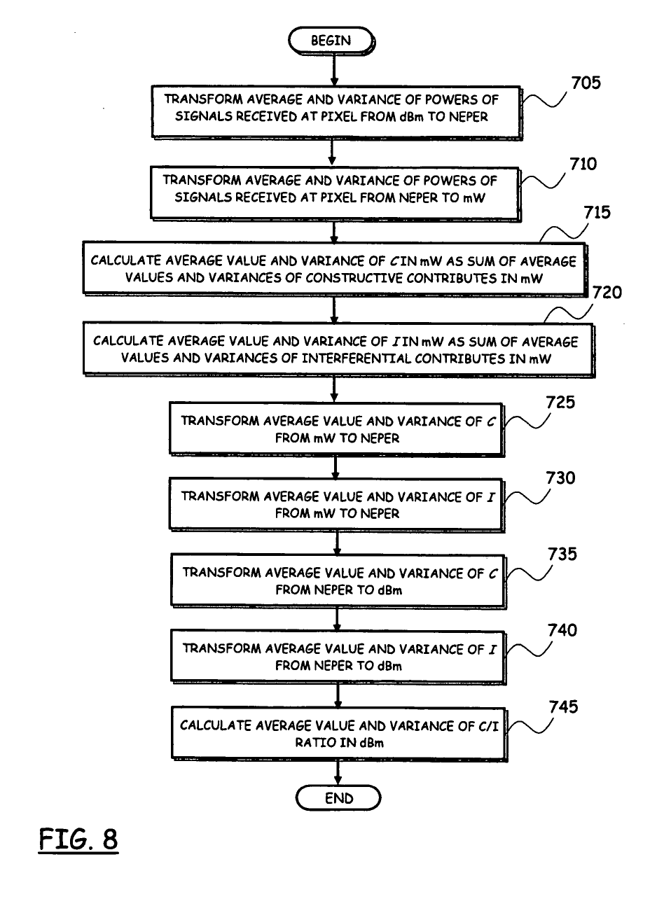

Based on the above considerations, the value of the C/1 ratio can be calculated as illustrated in the flowchart of FIG. 8.

As a result of the simulation performed by the electromagnetic field propagation simulator 505, n signals are received at the generic pixel, corresponding to the n different transmission stations; the power, in dBm, of each of the n signals is a stochastic variable having normal distribution, with average value μ_{P}_{ᵢ}[dBm] and standard deviation σ_{P}_{ᵢ}[dBm].

As a first step, the average values μ_{P}_{ᵢ}[dBm] and the variances σ_{P}_{ᵢ}[dBm] (with i=1 to n) in dBm are transformed into neper (block 705), using the above equations (eq. 1).

Then, the average values μ_{P}_{ᵢ}[neper] and the variances σ_{P}_{ᵢ}[neper] (with i=1 to n) in neper are transformed into mW (block 710), using the above equations (eq. 2).

Assuming, by way of approximation, that the virtual DVB-H receiver represented by the generic pixel of the area under planning regards as constructive contributions all the signals that are received within the decoding window, while the remaining signals are regarded as providing an interfering contribution, the statistical distributions of the useful signal C and of the interference I can be calculated in the following way:

$$C = {\sum }_{i , {t}_{0} \leq t \leq {t}_{0} + {T}_{u}} {C}_{i} ( t )$$

$$I = {\sum }_{i , t < {t}_{0} , t > {t}_{0} + {T}_{u}} {C}_{i} ( t )$$

where Cᵢ(t) denotes the power of the i-th signal irradiated by the i-th transmission station, in mW, calculated based on the simulation of the propagation of the electromagnetic field, and t₀ is the instant at which the start of the FFT window is from time to time positioned.

The average value μ_{C}[lin] and the variance σ_{C}²[lin] of the power (in mW) of the useful signal C are calculated as the sum of the average values and variances (in mW) of the constructive contributions (blocks 715); the same is done for the interference I, considering the interferential contributions (block 720).

Having the average value and the variance of the statistical distributions of the useful signal C and of the interference I, it is possible to calculate the ratio C/I. In fact, assuming that the two stochastic variables C and I are statistically uncorrelated, by performing the calculations in dBs the average value of the ratio C/I is equal to the difference, in dBs, of the average values of C and I, and the variance is equal to the sum of the variances of C and I in dBs. Preferably, the interference I is increased of an amount N being an additional interference contribution that takes into account all the other sources of interference (due to the environment).

In greater detail, the average value μ_{C}[neper] and μ_{I}[neper] and the variance σ_{C}[neper] and σ_{I}[neper] of C and I are calculated from the average value and variance in mW (blocks 725 and 730), using the formula (eq. 4) given above.

The average value and the variance μ_{C}[dBm] and μ_{I}[dBm] and the variance σ_{C}[dBm] and σ_{I}[dBm] of C and I are then calculated from the average value and variance in neper (blocks 735 and 740), using the formula (eq. 5) given above.

Finally, the average value and the variance of the ratio C/I, expressed in dBm, can be calculated as follows (block 745):

μ_{C/I}[dBm]=μ_{C}[dBm]−μ_{I}[dBm]

σ_{C/I}²[dBm]=σ_{C}²[dBm]+σ_{I}²[dBm]

The present invention has been here described in detail making reference to an exemplary embodiment; however, those skilled in the art will understand that several modifications to the described embodiment, as well as alternative embodiments are conceivable, without departing from the scope of the invention defined in the appended claims.

1-9. (canceled)

10. A method of planning a digital video broadcasting network in a geographic area of interest, comprising:
simulating an electromagnetic field propagation in a plurality of area elements of the area of interest;
for at least one area element of said plurality, performing a decoding of simulated radio signals which, as a result of said simulating, are received at said at least one area element; and
based on a result of said decoding, determining a service coverage in the area of interest,
the network being a digital video broadcasting-handheld network and said performing a decoding of the simulated radio signals comprises changing a position in time of a decoding time window.

11. The method of claim 10, wherein simulating an electromagnetic field propagation in a plurality of area elements of the area of interest comprises:
providing an initial configuration of the network in the area of interest;
providing a morphological description of the area of interest;
dividing the area of interest into a plurality of area elements; and
simulating a propagation of radio signals through the area of interest based on said initial configuration of the network.

12. The method of claim 10, wherein said performing a decoding comprises calculating a signal-to-noise ratio.

13. The method of claim 12, wherein said changing the position in time of the decoding time window comprises attempting to maximize the signal-to-noise ratio.

14. The method of claim 13, wherein said calculating the signal-to-noise ratio comprises considering as constructive contributions all the radio signals that, as a result of said simulating, are received at the area element within the decoding window, and considering as interferential contributions all the radio signals that, as a result of said simulating, are received at an area element outside the decoding window.

15. The method of claim 14, wherein said calculating the signal-to-noise ratio comprises treating said simulated signals as statistical distributions.

16. The method of claim 15, wherein said signal-to-noise ratio is the ratio between a useful signal and a noise, and said calculating the signal-to-noise ratio comprises:
transforming average values and variances of the received radio signals from a logarithmic unit into a linear unit;
calculating an average value and a variance of the useful signal as a sum of the average value and, respectively, of a variance of the constructive signal contributions, expressed in said linear unit;
calculating an average value and a variance of noise as a sum of an average value and, respectively, of a variance of the interferential contributions, expressed in said linear unit;
converting the calculated average value and variance of the useful signal from said linear unit into said logarithmic unit;
converting the calculated average value and variance of the noise from said linear unit into said logarithmic unit;
calculating an average value of said ratio between the useful signal and the noise in said logarithmic unit as a difference of the average values of the useful signal and of the noise in said logarithmic unit; and
calculating a variance of said ratio between the useful signal and the noise in said logarithmic unit as a sum of the variances of the useful signal and of the noise in said logarithmic unit.

17. A computer program comprising instructions adapted to implement the method according to claim 10, when executed.

18. A data processing system adapted to implement the method according to claim 10, when programmed to execute a computer program comprising instructions adapted to implement the method according to claim 10.
